(19) United States
(12) Patent Application Publication
(10) Pub. No.: US 2011/0201529 A1
(43) Pub. Date: Aug. 18, 2011

(54) SYSTEM FOR ANALYZING AND SCREENING DISEASE RELATED GENES USING MICROARRAY DATABASE

(76) Inventors: Liang-Tsung Huang, Changhua County (TW); Chang-Sheng Wang, Taichung City (TW)

(21) Appl. No.: 12/705,077

(22) Filed: Feb. 12, 2010

(51) Int. Cl. C40B 60/04

(52) U.S. Cl. 506/35

(57) ABSTRACT

The present invention provides a system for analyzing and screening disease related genes from microarray database. After normalizing the collected microarray datasets and related experiment data by using pre-processing unit, the relative important feature vector can be systematically extracted by the feature selection unit. The maximal likelihood discriminate rule of classification unit calculates probability statistics of the classification and diagonal quadratic discriminant analysis module is used to decide classification and set up disease prediction module. Also, the generalized rule induction information statistics calculation module of rule extraction unit is used to obtain organized information statistics and information theoretic rule induction algorithm module is employed to generate best relationship rule and associate rule module can be set up. By using present invention, the relationships between diseases and related genes can be accurately and rapidly identified, a solid foundation can be set up for the afterward diagnostic and treatment.

### BACKGROUND OF THE INVENTION

1. Field of the Invention

The present invention relates to a system for analyzing and screening disease related genes from microarray database, which mainly concerns biological information field of process, analysis, and evaluation of microarray database, and predicting the biological meaning of the database.

2. Description of the Prior Art

Microarray analysis has become an important tool for research in the genomics and genetics field. The microarray provides thousands of nucleic acid probes and peptide probes. A large scale of gene expression and sequence information can be rapidly retrieved by a single test. However, the database retrieved from the microarray analysis is too large in quantity and the researchers have difficulty rapidly analyzing the database for the biological significance, such as the gene expression profiling, and relations between diseases and genes. Therefore, how to find the biological significance from the large scale database of microarray analysis is the goal of the present biological information technologies.

For example, such biological information technologies use the microarray technologies associated with the bioinformatics software to find some particular gene expression to distinguish the acute lymphoblastic leukemia (ALL) from the acute myeloid leukemia (AML). In other words, by using the information from the microarray sufficiently and correctly, it will assist medical staff in deeply understanding the diseases.

However, it is difficult to identify different disease types from thousands of gene expressions. Insufficient experimental data is an issue. Besides, an efficient and accurate structuralized and systematized system for analyzing prediction and establishing relationship modules is not yet available. Recently, many machine learning methods, such as artificial neural nets, are applied in prediction. However, the nodes of the artificial neural nets have strong reciprocal effects and thus the characters of the system are not easy to be explained, which limits further analysis of the prediction mechanism.

Therefore, based on microarray technologies, how to use different level bioinformatics technologies and software to deeply develop related researches of knowledge engineering and data mining has become an important issue. Thus it can be seen that the aforementioned conventional products still have many drawbacks and are not good in design, thus the aforementioned products need to be improved.

The inventors consider improvement in view of the aforementioned drawbacks of the conventional products, and develop the present invention of a system for analyzing and screening disease related genes using microarray database.

Besides, the contents of the application are disclosed in the Journal of Biomedical Science 2009, 16:25, on Feb. 24, 2009.

### SUMMARY OF THE INVENTION

The primary objective of the present invention is to provide a system for analyzing and screening disease related genes using microarray database. The system is applied to rapidly and accurately predict diseases by analyzing the database(s) of microarray, sequentially processing the large scale database, screening out important candidate genes, then developing diseases prediction module.

Another objective of the present invention is to provide a system for analyzing and screening disease related genes from microarray database. The system is applied to rapidly identify the relationship between the diseases and the genes by analyzing the database of the microarray, sequentially processing the large scale database, screening out important candidate genes, and then developing associate rule module.

In order to achieve the above-described objects of the invention, comprising: First, collecting different samples of microarray data and the related experimental data, then a pre-processing unit is configured to normalize the microarray data collected, and the threshold values of gene expression are set up for getting the gene expression data within the range of threshold values. Second, a chi-square statistic calculation module and a chi-square algorithm module of the feature selection unit are configured to find out the data with significant different gene expressions by eliminating the similar gene expression data. Finally, the data with significant difference in expressions, also called the candidate gene or the feature vector in the present application, are screened out as the input vectors for the classification unit or the rule extraction unit.

The classification unit comprises a maximal likelihood discriminate rule calculation module and a diagonal quadratic discriminant analysis module, in which the maximal likelihood discriminate rule calculation module is configured to predict possibility of disease classifications based on Bayes decision theory, and then the diagonal quadratic discriminant analysis module is configured to determine the classifications of disease for establishing the disease prediction module.

The rule extraction unit comprises a generalized rule induction information statistics calculation module and an information theoretic rule induction algorithm module. The rule extraction unit is configured to evaluate the information content of associate rule obtained by the generalized rule induction information statistics calculation module, generating the best associated rule by the information theoretic rule induction algorithm to establish the associate rule module.

It is able to accurately and rapidly find the expression of particular genes and then identify corresponding disease classifications through the system provided by present invention for a further diagnosis and/or therapy. Further, the system is able to establish the possible relationship between the diseases and genes.

These features and advantages of the present invention will be fully understood and appreciated from the following detailed description of the accompanying drawings.

### BRIEF DESCRIPTION OF THE DRAWINGS

FIG. 1 shows a structural diagram of the system in the present invention;

FIG. 2 shows the predicted performance of the X-AI system along with different number of genes on the test sets of two datasets; and

FIG. 3A shows a comparison diagram representing the number of misclassifications among the X-AI and other prediction methods. The analysis and comparison is based on the test set of L1. FIG. 3B shows a comparison diagram representing accuracy among the X-AI and other prediction methods. The analysis and comparison is based on the test set of L2, in which the Voting machine [1]-SVM [8]-Emerging-patterns [9]-MAMA [10]-J48, NB, SMO-CFS, SMO-Wrapper [7]-RIRLS, RPLS, RPCR, FPLS, MAVE, k-NN [11] shown in FIG. 3A are conventional analysis methods; and the classification methods based on correlation/ordering network [12]-HC-TSP, HC-k-TSP, DT, NB, k-NN, SVM, PAM [13] shown in FIG. 3B are conventional analysis methods.

### DETAILED DESCRIPTION OF THE PREFERRED EMBODIMENT

The invention will be illustrated with the examples as follows, without the intention that the invention is limited thereto.

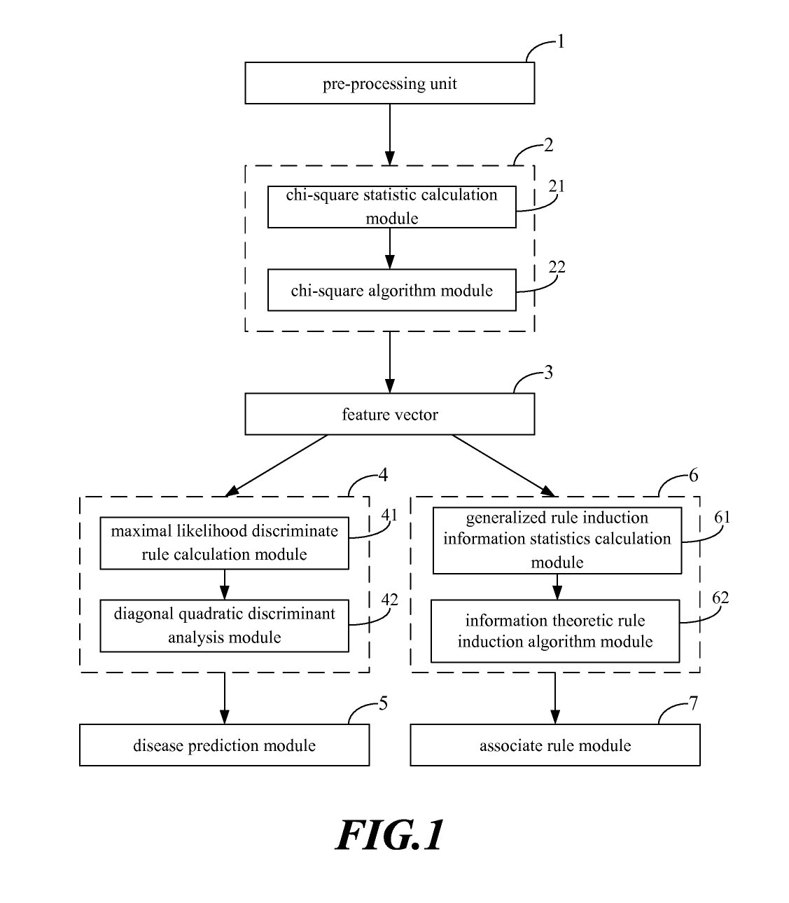

FIG. 1 shows a structural diagram of a system for analyzing and screening disease related genes using microarray database of the present invention, hereinafter X-AI, comprising:

A pre-processing unit 1: The pre-processing unit 1 is configured to process normalization of microarray data (gene expression values) from the same sample to ensure the microarray data with consistency among different samples. The multiplexing factor is calculated based on the slope of linear regression of the gene expression values with present calls. Generally, it's conventional that the researcher would calculate the multiplexing factor. The multiplexing factor is adapted to correct the gene expression values of different samples to prevent the errors produced from the operation process among samples. The present calls mean the genes have the same expressions among different samples. Thus, by processing linear regression of present calls, it's able to retrieve the multiplexing factor for following correction. Further, the threshold values of gene expression values are determined for getting the data within the range of threshold values. The X-AI system can further comprise a threshold filter; it can be applied to prevent extreme values of database which might cause bias or variation.

Since the original microarray database after processed by the pre-processing unit 1 still contains many gene expression data, it's preferred to select a representative gene for following analysis and classification to decrease the number of the feature vectors 3 and enhance the performance of the X-AI system. Besides, the feature vector 3 directly relates to establish the associate rule module 7. Therefore, to reduce possible redundant gene expression data and complexity of calculation, the X-AI system applies chi-square statistic calculation module 21 and chi-square algorithm module 22 to perform analysis and selection of important genes and then the system selects relatively important genes as the input vectors of classification unit 4 or rule extraction unit 6.

A feature selection unit 2: The feature selection unit 2 comprises the chi-square statistic calculation module 21 and the chi-square algorithm module 22. The chi-square statistic calculation module is configured to apply the chi-square algorithm to calculate the chi-square statistics of adjacent intervals, and the chi-square algorithm module 22 is configured to combine the adjacent intervals according to the set threshold values to extract an relatively important gene as the input feature vector 3 of the classification unit 4 and the rule extraction unit 6.

The aforementioned “feature vector” in the present invention is the selected candidate gene combination as the inputs of classification unit 4 and the rule extraction unit 6 for determining the classification of diseases and establishing the best relationship or associate rules.

A classification unit 4: The classification unit 4 is configured to apply the feature vector 3 as the input vector, and calculate probability statistics of classification to predict the possibility of classification by the Maximal Likelihood Discriminate Rule calculation module 41. Then the diagonal quadratic discriminant analysis module 42 is applied to determine the predicted classification for establishing the disease prediction module 5.

A rule extraction unit 6: The rule extraction unit 6 is configured to apply the feature vector 3 as the input vector, then to evaluate the information content of associate rule according to the information statistics obtained by the generalized rule induction information statistics calculation module 61. The information statisticsgenerate a reliable relationship or associate rule by the information theoretic rule induction algorithm (ITRULE) module 62 for establishing associate rule module 7.

Besides, the present invention also provides a computer readable medium with stored program, when the computer installs and executes the program, it is able to perform the system (X-AI) for analyzing and screening disease related genes using microarray database.

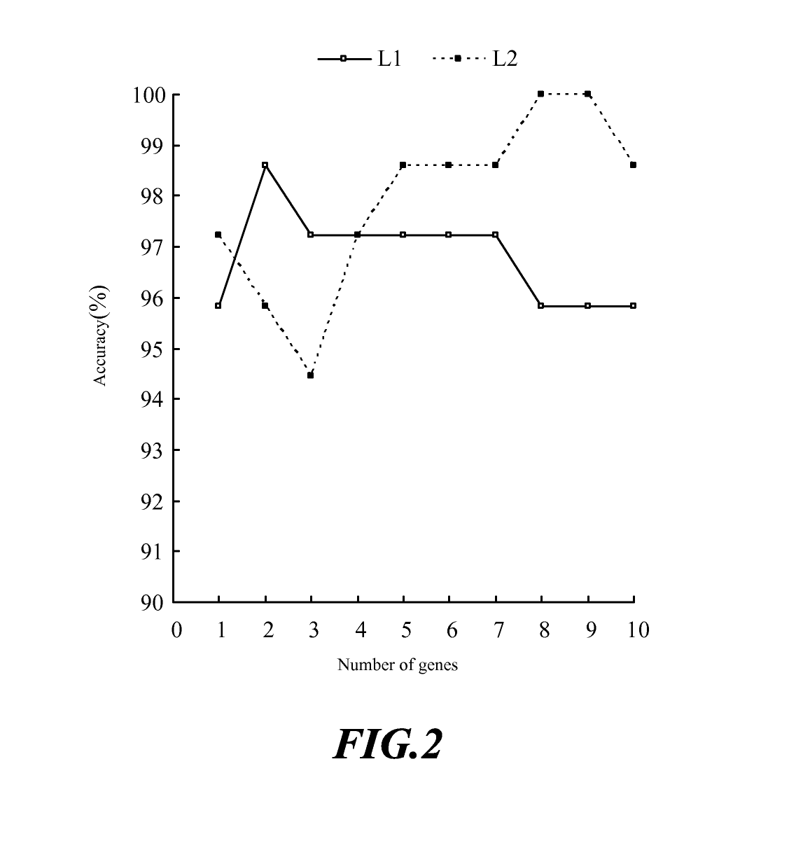

Regarding FIGS. 1, 2 and Tables 1, 2, two different leukemia data sets are shown in the embodiment of the present invention. By reviewing detailed algorithm flow and providing corresponding data, the accuracy of the X-AI is examined.

The first data set is retrieved from Golub et al [1] (hereinafter the L1 set), and contains 72 samples including training sets with 27 ALLs, 11 AMLs, and testing sets with 20 ALLs, and 14 AMLs. The training sets and testing sets of two categories (ALL, AML) leukemia are taken for Affymetrix oligonucleotide microarray, in which every sample contains 7129 gene (probe) expressions.

The second data set is retrieved from Armstrong et al [2] (hereinafter the L2 set), and contains 72 samples including training sets with 20 ALLs, 17 MLLs (Mixed Lineage Leukemia), and 20 AML, and testing sets with 4 ALLs, 3 MLLs, and 8 AMLs. The training sets and testing sets of three categories (ALL, MLL, AML) leukemia are taken for Affymetrix oligonucleotide microarray, in which every sample contains 12582 gene (probe) expressions.

Since the L1 set and L2 set are different, the linear regression of gene samples is calculated to reduce the bias due to inconsistent standard of data. Then the multiplexing factor is applied to normalize all expressions.

TABLE 1 A
L1 set with samples and the multiplexing factor thereof

| sample | multiplexing factor |
|---|---|
| ALL_1 | 1 |
| ALL_2 | 0.9564 |
| ALL_3 | 1.1405 |
| ALL_4 | 1.0657 |
| ALL_5 | 1.0379 |
| ALL_6 | 1.7782 |
| ALL_7 | 1.6803 |
| ALL_8 | 1.4993 |
| ALL_9 | 0.9251 |
| ALL_10 | 1.2078 |
| ALL_11 | 1.0709 |
| ALL_12 | 1.4371 |
| ALL_13 | 1.1240 |
| ALL_14 | 0.9890 |
| ALL_15 | 0.9211 |
| ALL_16 | 1.0510 |
| ALL_17 | 1.0938 |
| ALL_18 | 1.1875 |
| ALL_19 | 1.1289 |
| ALL_20 | 0.8150 |
| ALL_21 | 1.2493 |
| ALL_22 | 1.3078 |
| ALL_23 | 1.8999 |
| ALL_24 | 1.0876 |
| ALL_25 | 1.0961 |
| ALL_26 | 1.0198 |
| ALL_27 | 1.5647 |
| AML_1 | 0.9555 |
| AML_2 | 1.3320 |
| AML_3 | 1.0136 |
| AML_4 | 1.3080 |
| AML_5 | 1.0751 |
| AML_6 | 1.0958 |
| AML_7 | 1.0541 |
| AML_8 | 2.4046 |
| AML_9 | 1.1979 |
| AML_10 | 1.0697 |
| AML_11 | 1.1490 |
| ALL_28 | 2.4140 |
| ALL_29 | 1.4640 |
| ALL_30 | 1.5654 |
| ALL_31 | 1.3826 |
| ALL_32 | 2.4037 |
| ALL_33 | 1.4825 |
| ALL_34 | 1.2147 |
| ALL_35 | 1.4439 |
| ALL_36 | 2.1014 |
| ALL_37 | 0.9503 |
| ALL_38 | 1.4246 |
| AML_12 | 1.0369 |
| AML_13 | 2.0114 |
| AML_14 | 1.1434 |
| AML_15 | 1.1210 |
| AML_16 | 1.5589 |
| ALL_39 | 2.4965 |
| ALL_40 | 2.5750 |
| AML_17 | 1.9655 |
| AML_18 | 3.0910 |
| ALL_41 | 2.5419 |
| AML_19 | 1.5861 |
| AML_20 | 2.1674 |
| AML_21 | 2.3168 |
| AML_22 | 1.0679 |
| AML_23 | 2.7110 |
| AML_24 | 1.3222 |
| AML_25 | 2.1734 |
| ALL_42 | 1.3626 |
| ALL_43 | 1.0689 |
| ALL_44 | 0.9195 |
| ALL_45 | 1.5470 |
| ALL_46 | 1.0785 |
| ALL_47 | 1.3331 |

TABLE 1 B
L2 set with samples and the multiplexing factor thereof

| sample | multiplexing factor |
|---|---|
| ALL_1 | 1 |
| ALL_2 | 0.9399 |
| ALL_3 | 1.6781 |
| ALL_4 | 1.0635 |
| ALL_5 | 1.3875 |
| ALL_6 | 1.1869 |
| ALL_7 | 1.1951 |
| ALL_8 | 1.2615 |
| ALL_9 | 1.5606 |
| ALL_10 | 1.2855 |
| ALL_11 | 1.1064 |
| ALL_12 | 1.2399 |
| ALL_13 | 1.4928 |
| ALL_14 | 1.0762 |
| ALL_15 | 1.3057 |
| ALL_16 | 1.1453 |
| ALL_17 | 1.1352 |
| ALL_18 | 1.1639 |
| ALL_19 | 1.2322 |
| ALL_20 | 1.2835 |
| ALL_21 | 1.1707 |
| ALL_22 | 1.2464 |
| ALL_23 | 1.3895 |
| ALL_24 | 1.3123 |
| MLL_1 | 1.1768 |
| MLL_2 | 1.2505 |
| MLL_3 | 1.1265 |
| MLL_4 | 1.4482 |
| MLL_5 | 1.2887 |
| MLL_6 | 1.5538 |
| MLL_7 | 1.6762 |
| MLL_8 | 1.3806 |
| MLL_9 | 2.0938 |
| MLL_10 | 1.2386 |
| MLL_11 | 1.5635 |
| MLL_12 | 1.423 |
| MLL_13 | 1.1919 |
| MLL_14 | 1.3583 |
| MLL_15 | 1.1411 |
| MLL_16 | 1.2512 |
| MLL_17 | 1.2028 |
| MLL_18 | 1.1527 |
| MLL_19 | 1.2507 |
| MLL_20 | 1.011 |
| AML_1 | 1.6128 |
| AML_2 | 2.0453 |
| AML_3 | 1.3752 |
| AML_4 | 1.7968 |
| AML_5 | 1.915 |
| AML_6 | 1.5085 |
| AML_7 | 1.4697 |
| AML_8 | 1.7937 |
| AML_9 | 1.3775 |
| AML_10 | 1.5394 |
| AML_11 | 1.6809 |
| AML_12 | 1.2849 |
| AML_13 | 1.3148 |
| AML_14 | 1.7796 |
| AML_15 | 2.0699 |
| AML_16 | 1.4759 |
| AML_17 | 1.5584 |
| AML_18 | 1.3974 |
| AML_19 | 1.2468 |
| AML_20 | 1.7799 |
| AML_21 | 1.4612 |
| AML_22 | 1.4977 |
| AML_23 | 1.4006 |
| AML_24 | 1.648 |
| AML_25 | 1.6035 |
| AML_26 | 1.7503 |
| AML_27 | 1.7118 |
| AML_28 | 2.1268 |

### Disease Prediction

After the gene expression values are normalized, the threshold values of the gene expression values are set from −800 to 24000 for getting the gene expression values within the range. Besides, to prevent extreme values of the database that might cause variation or bias, the Duoit's [3] of data process can be further applied.

After processed by the pre-processing unit 1, the data are reduced but still too large for disease prediction. Therefore, a feature selection unit 2 is applied for analysis of the important gene. The feature selection unit 2 mainly contains two stages. The first stage comprises a chi-square statistic calculation module 21 being configured to calculate the chi-square statistics, values or scores (χ²) of adjacent intervals by chi-square Algorithm and combine the adjacent intervals. The second stage comprises a chi-square Algorithm module 22 being configured to evaluate the combination degree. The genes with a larger combination degree represent relative lower importance to the data. Finally each gene is rearranged to indicate the relative importance between genes.

The feature selection unit 2 applies equations as follows:

$${χ}^{2} = {\sum }_{i = 1}^{2} {\sum }_{j = 1}^{k} \frac{{( {A}_{ij} - {E}_{ij} )}^{2}}{{E}_{ij}}$$

$$and$$

$${E}_{ij} = \frac{{R}_{i} * {C}_{j}}{n} ,$$

in which the k is category size, the Aᵢⱼ is the sample size of the jth category in the ith interval, the Eᵢⱼ is the expected value of Aᵢⱼ, the Rᵢ is the sample size of the i-th interval, the Cⱼ is the sample size of the j-th category, and the n is the total sample size.

Taking the data set L1 set of the present invention as an example, K=2 means categories of ALL and AML. The initial interval contains a number representing the multiplicity of one gene expression value. For example, the first gene expression value has an interval number 66; the first interval has a sample size R₁=72. Taking ALL as an example, the sample size of the category ALL is C_{ALL}=47, and total sample size is n=72. More detailed calculation flow of algorithm can be achieved by open source code software [5]. (For more detailed algorithm, please refer to Chi2-feature selection and discretization of numeric attributes [4])

Therefore, the feature selection unit 2 is configured to screen and select relatively important genes as the feature vectors 3 of the classification unit 4 and rule extraction unit 6. Table 2 shows the top ten feature vectors 3 of the L1 set and L2 set selected by the feature selection unit 2 as follows.

TABLE 2

| Dataset | Probe ID | Gene annotation | χ² Score |
|---|---|---|---|
| L1 | X95735 | Zyxin | 38.00 |
| | M55150 | FAH Fumarylacetoacetate | 33.54 |
| | M27891 | CST3 Cystatin C(amyloid angiopathy and | 33.31 |
| | | cerebral hemorrhage) | |
| | M31166 | PTX3 Pentaxin-related gene, rapidly | 33.31 |
| | | induced by IL-I beta | |
| | X70297 | CHRNA7 Cholinergic receptor, nicotinic, | 29.77 |
| | | alpha polypepeide 7 | |
| | U46499 | GLUTATHIONE | 29.77 |
| | | S-TRANSFERASE, MICROSOMAL | |
| | L09209_s | APLP2 Amyloid beta (A4) precursor-like | 29.77 |
| | | protein 2 | |
| | M77142 | NUCLEOLYSIN TIA-I | 29.77 |
| | J03930 | ALKALINE PHOSPHATASE, INTESTINAL | 29.02 |
| | | PRECURSOR | |
| | M23197 | CD33 CD33 antigen(differentiation antigen) | 28.95 |
| L2 | 36239_at | H. sapiens mRNA for oct-bindind factor | 91.08 |
| | 37539_at | Homo sapiens mRNA for KIAA0905 | 84.51 |
| | | protein, partial cds | |
| | 35260_at | Homo sapiens mRNA for KIAA0867 | 83.72 |
| | | protein, complete cds | |
| | 32847_at | Homo sapiens myosin light chain | 79.82 |
| | | kinase(MLCK) mRNA, complete cds | |
| | 35164_at | Homo sapiens transmembrance protein(WFSI) | 79.46 |
| | | mRNA, complete cds | |
| | 1325_at | Homo sapiens TWIK-related acid-sensitive K+ | 78.57 |
| | | channel (TASK) mRNA, complete cds | |
| | 40191_s_at | Wg66h09.xl Homo sapiens cDNA, 3′ end | 77.22 |
| | 39318_at | H. sapiens mRNA for Tcell leukemia | 76.22 |
| | 32573_at | Human transcriptional activator (BRGI) | 74.97 |
| | | mRNA, complete cds | |
| | 41715_at | H. sapiens mRNA for phosphoinositide | 73.53 |
| | | 3-kinase | |

The classification unit 4 uses the maximal likelihood discriminate rule calculation module 41 of Bayes decision theory to evaluate the feature vectors 3 and the possibility of corresponding categories thereof.

For a multivariate Gaussian distribution, the maximal likelihood discriminate rule calculation module 41 applies the algorithm as follow [6]:

$$p ( x \vert {ω}_{i} ) = \frac{1}{{( 2 π )}^{l / 2} {\vert {Σ}_{i} \vert}^{1 / 2}} exp [ - \frac{1}{2} {( x - {μ}_{i} )}^{T} {Σ}_{i}^{- 1} ( x - {μ}_{i} ) ] ,$$

in which the “l” represents the space dimension of the vector x, μᵢ is the expected vector of x in ωᵢ category, and Σᵢ is a l×l covariance matrix.

Taking the data set L1 of the embodiment of the present invention as an example, ten important genes are selected, therefore 1=10, and the expressions value of the ten selected important genes represent the feature vectors 3. The ω_{ALL} represents the category is ALL, and the μ_{ALL} represents the expected vector of the training samples of the ALL category, that is the averaged vector of all feature vectors 3 (denoted as vector x in equation) of the training samples in the ALL category.

When the covariance matrix is a diagonal matrix, that is Σᵢ=diag(σᵢ₁², . . . , σᵢₗ²), the maximal likelihood discriminate rule calculation module 41 can be considered as

$$C ( x ) = {arg min}_{i} {\sum }_{j = 1}^{l} [ {( {x}_{j} - {μ}_{ij} )}^{2} / {σ}_{ij}^{2} + log {σ}_{ij}^{2} ] ,$$

which is a particular form of the diaquadratic discriminate equation (diagonal quadratic discriminate analysis module 42). In practice, the μᵢ and Σᵢ can be known based on the corresponding samples [7] (i.e. calculating the expected vector μᵢ and the covariance matrix Σᵢ of the data sets L1 and L2 without calculating the expected vector and the covariance matrix of the unknown population) thereby the particular form can be applied to determine the prediction category or classification for establishing the disease prediction module 5.

FIG. 2 shows the predicted performance of data sets of the testing sets of the L1 and L2 sets in X-AI. The x axis represents the number of genes, and the y axis represents the accuracy (%). The result shows the high accuracy of the X-AI system, no matter how many genes are taken for determination.

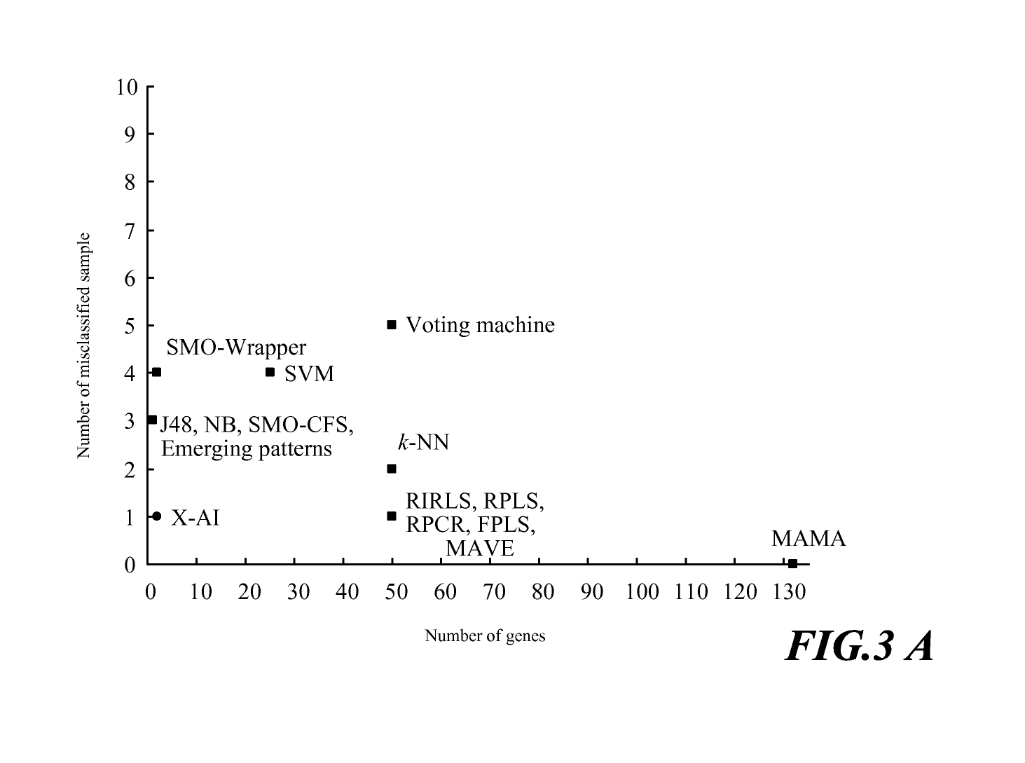

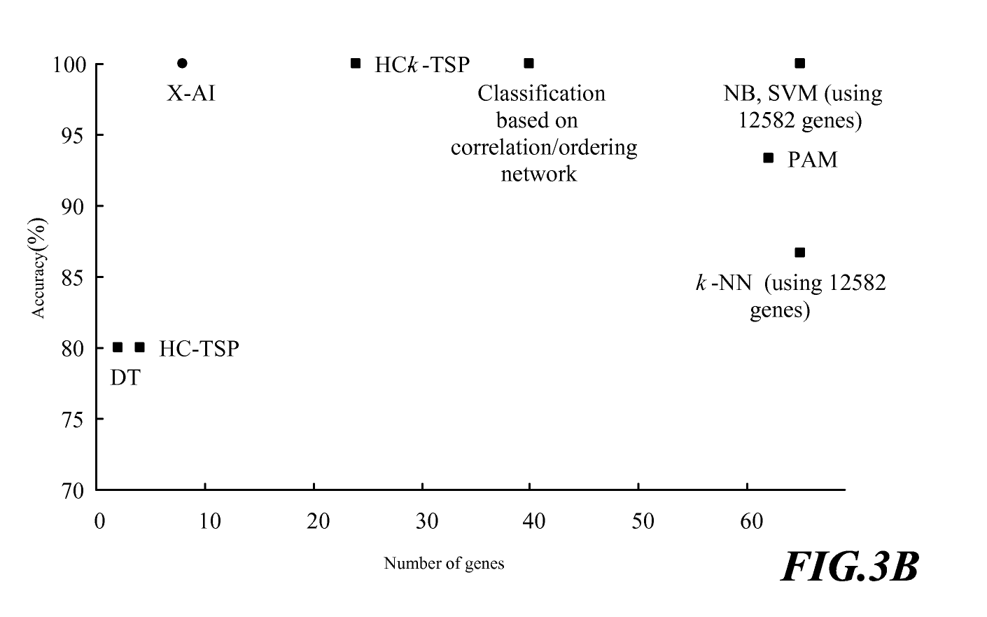

FIG. 3A shows a comparison diagram representing prediction performance among the X-AI and other prediction methods, the data sets of L1 testing set is taken for analysis and comparison. The x-axis represents the number of genes, and the y axis represents the number of misclassified sample. It is clearly shown that the X-AI system only needs the minimum number of genes to present the lowest error percentage.

FIG. 3B shows a comparison diagram representing prediction performance among the X-AI and other prediction methods, the data sets of testing set of L2 set is taken for analysis and comparison. The x-axis represents the number of genes, and the y axis represents the accuracy (%). It is clearly shown that the X-AI system only needs the minimum number of genes to present the highest accuracy.

As aforementioned, the X-AI system of the present invention is able to rapidly and accurately determine the classification of corresponding disease by the established disease prediction module 5 thereof. The present invention is helpful in early diagnosis and preventive medicine and thus assists in efficiently using the medical resources, health insurance, and medical insurance.

### Developing Relationship/Associate Rule

Besides, to effectively use the microarray database and provide higher value, it is important to develop the relationship/associate rule to reduce potential and large-scale random database and restrain them into a few and easy observing static database. The generalized rule induction information statistics calculation module 61 of rule extraction unit 6 takes the aforementioned feature vectors 3 as the input to evaluate the information content of the statistics.

The generalized rule induction information statistics calculation module 61 retrieves statistics as follow:

$$J = p ( a ) [ p ( b \vert a ) ln \frac{p ( b \vert a )}{p ( b )} + [ 1 - p ( b \vert a ) ] ln \frac{1 - p ( b \vert a )}{1 - p ( b )} ] ,$$

If A=a, B=b, wherein said “A” represents parameter of antecedent, “a” represents observation value of parameter A, the p(a) represents the probability of factor observation value a, i.e. the covering degree of the antecedent of the rule, and “B” represents parameter of consequent, “b” represents observation value of parameter B, the p(b) represents the prior probability of factor observation value b, i.e. the general degree of consequent, the p(b|a) represents the correction probability of factor observation value b after added observation value a, thereby for a rule with multi-antecedents, and the P(a) is treated as a joint probability of the antecedent with multi-observation values (i.e. p(a₁ AND a₂)).

According to the statistic value generated by the generalized rule induction information statistics calculation module 61, the information theoretic rule induction algorithm module 62 is configured to generate a best rule and establish the associate rule module 7.

The detail of the information theoretic rule induction algorithm module 62 can be described as the following steps:

Step 1: retrieving a rule with designated quantity by calculating and sequentially arranging all J statistics of first-order rules from sample data, and setting the minimum J statistics as the Jₘᵢₙ;

Step 2: characterizing all rules in Step 1, that is, adding new antecedent and then evaluating the J statistics of newly formed rules;

Step 3: determining whether continuously characterizing the rules by a depth-first algorithm strategy, and replacing the elder rule by the searched rule with the J statistics larger than the Jₘᵢₙ until the P(b|a) equals to 0 or 1. Please refer to [8] for more detailed steps of algorithm.

Refer to Tables 3A and 3B, the Table 3A represents the rules corresponding to the two different categories derived from the L1 set by the X-AI, as well as the Table 3B represents the rules corresponding to the three different categories derived from the L2 set by the X-AI. The data explicitly shows that the Confidence is larger than the Support, which means the antecedent is related to the consequent, wherein the

Support=the number (or quantity) of containing antecedent's samples divides by the total sample size.

Confidence=the number (or quantity) of containing antecedent and consequent's samples divides by the number (or quantity) of containing antecedent's samples.

TABLE 3A

| Consequent | Antecedent | Support | Confidence |
|---|---|---|---|
| ALL | L09209_s > 1056.5 & | 30.56 | 100 |
| | M23197 > 326.0 | | |
| | M23197 > 401.5 | 29.17 | 100 |
| | M27891 > 2096.5 | 27.78 | 100 |
| | X95735 > 994.0 & | 27.78 | 100 |
| | M55150 > 1250.5 | | |
| | X95735 > 994.0 | 36.11 | 92 |
| AML | U46499 < 154.5 | 59.72 | 100 |
| | L09209_s < 992.5 | 58.33 | 100 |
| | X95735 < 994.0 | 63.89 | 98 |
| Mean | | 41.67 | 99 |

TABLE 3B

| Consequent | Antecedent | Support | Confidence |
|---|---|---|---|
| ALL | 32847_at > 147.0 | 30.56 | 100 |
| | 36239_at > 2201.0 | 27.78 | 100 |
| AML | 39318_at < 1063.0 & 32579_at < 2285.0 | 34.72 | 100 |
| | 1325_at < 1501.5, 39318_at < 1063.0 & | 34.72 | 100 |
| | 32579_at < 2285.0 | | |
| | 1325_at < 1501.5, 36239_at < 214.0 & | 33.33 | 100 |
| | 40191_s_at < 508.5 | | |
| | 36239_at < 214.0 & 40191_s_at < 508.5 | 33.33 | 100 |
| | 39318_at < 1063.0 & 35164_at < −794.5 | 31.94 | 100 |
| | 40191_s_at < 519.0 & 36239_at < 167.0 | 31.94 | 100 |
| | 1325_at < 1501.5, 39318_at < 1063.0 & | 31.94 | 100 |
| | 35164_at < −794.5 | | |
| | 1325_at < 1501.5, 40191_s_at < 519.0 & | 31.94 | 100 |
| | 36239_at < 167.0 | | |
| | 1325_at < 1501.5, 36239_at < 214.0 & | 31.94 | 100 |
| | 37539_at < −362.0 | | |
| | 36239_at < 214.0 & 37539_at < −362 | 31.94 | 100 |
| | 37539_at < −725.5 | 29.17 | 100 |
| | 32579_at < 2285.0 | 36.11 | 96 |
| | 1325_at < 1501.5 & 32579_at < 2285.0 | 36.11 | 96 |
| | 36239_at < 214.0 | 40.28 | 93 |
| MLL | 1325_at < 201.0, 35260_at > 794.5 & | 19.44 | 100 |
| | 40191_s_at > 1107.5 | | |
| | 1325_at < 201.0 & 36239_at > 214.0 | 23.61 | 94 |
| | 1325_at < 201.0 | 37.50 | 67 |
| Mean | | 32.02 | 97 |

The system for analyzing and screening disease related genes using microarray database of the present invention, comparing with other conventional technologies, is advantaged as follows.

1. The present invention is able to rapidly and accurately find the gene related to diseases among large-scale microarray database. Compared with the conventional technologies, the present invention only needs a few gene samples for predicting and determining the categories or classifications of diseases with high accuracy. The present invention is helpful in early diagnosis and preventive medicine and thus assists in efficiently using the medical resources, health insurance, and medical insurance.

2. Refer to conventional technologies, the present invention only needs a few gene samples among large-scale microarray database for calculating the joint probability among genes and the corresponding diseases by the algorithm of rule extraction unit. Therefore, a reliable disease associate rule module can be developed.

3. The present invention provides a systematic data mining algorithm process comprising the sequential operations of the pre-processing unit, the feature selection unit, the classification unit or the rule extraction unit. The present invention is able to find the important gene expression values among the complex microarray database and then classify the corresponding diseases or further establish a best relationship or associate rule.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A system for analyzing and screening disease related genes using microarray database, comprising:
a pre-processing unit, being configured to normalize the microarray database of the same sample, set a threshold value range of gene expression, then to retrieve gene expression database within the threshold value range;
a feature selection unit, being configured to filter and subtract the similar of the gene expression database for reducing calculating complexity, and to extract the important gene with significant different performance as a feature vector; and
a classification unit, being configured to take the feature vector as an input vector, and to evaluate a disease corresponding to the feature vector by a particular algorithm, then to establish a disease prediction module.

2. The system as claimed in claim 1, wherein the feature selection unit comprises a chi-square statistic calculation module and a chi-square algorithm module, the chi-square statistic calculation module is configured to calculate the chi-square statistics of adjacent intervals by chi-square algorithm, and the chi-square algorithm module is configured to combine the adjacent intervals to extract an important gene with significant different performance.

3. The system as claimed in claim 2, wherein the chi-square statistic calculation module and the chi-square algorithm module applies the equation of
$${χ}^{2} = {\sum }_{i = 1}^{2} {\sum }_{j = 1}^{k} \frac{{( {A}_{ij} - {E}_{ij} )}^{2}}{{E}_{ij}}$$
in which the k is category size Aᵢⱼ the is the sample size of the jth category in the ith interval, the Eᵢⱼ is the expected value of Aᵢⱼ, the Rᵢ is the sample size of the i-th interval, the Cⱼ is the sample size of the j-th category, and the n is the total sample size.

4. The system as claimed in claim 1, wherein the particular algorithm of the classification unit comprises a maximal likelihood discriminate rule calculation module for calculating the probability statistics of categories to evaluate the probability of the categories, and determine the category by diagonal quadratic discriminant Analysis module to establish the disease prediction module.

5. The system as claimed in claim 4, wherein the maximal likelihood discriminate rule calculation module is configured to predict the category according to the maximum likelihood generated by the feature vector (denoted as vector x in equations), in which for the Multivariate Gaussian distribution, the maximum likelihood function of the category ωᵢ and the vector x denotes as follows:
$$p ( x \vert {ω}_{i} ) = \frac{1}{{( 2 π )}^{l / 2} {\vert {Σ}_{i} \vert}^{1 / 2}} exp [ - \frac{1}{2} {( x - {μ}_{i} )}^{T} {Σ}_{i}^{- 1} ( x - {μ}_{i} ) ]$$
in which the l represents the space dimension of the vector x, μᵢ is the expected vector of x in ωᵢ category, and Eᵢ is a l×l covariance matrix.

6. The system as claimed in claim 4, wherein the diagonal quadratic discriminant analysis module exists when the covariance matrix is a Diagonal matrix, that is Σᵢ =diag(σᵢ₁², . . . , σᵢₗ²), the maximal likelihood discriminate rule can be considered as
$$C ( x ) = {arg min}_{i} {\sum }_{j = 1}^{l} [ {( {x}_{j} - {μ}_{ij} )}^{2} / {σ}_{ij}^{2} + log {σ}_{ij}^{2} ] ,$$
which is a particular form of the diaquadratic discriminate equation, thereby the particular form can be applied to determine the prediction category for establishing the disease prediction module.

7. The system as claimed in claim 1, wherein the disease is leukemia, and the threshold value range of the gene expression is from −800 to 24000.

8. A system for analyzing and screening disease related genes using microarray database, comprising:
a pre-processing unit, being configured to normalize the microarray database of the same sample, set a threshold value range of gene expression, then to retrieve gene expression database within the threshold value range;
a feature selection unit, being configured to filter and subtract the similar of the gene expression database for reducing calculating complexity, and to extract the important gene with significant different performance as a feature vector; and
a rule extraction unit, being configured to obtain joint probability of multi-observation values by a particular algorithm to establish a relationship rule module.

9. The system as claimed in claim 8, wherein the rule extraction unit is configured to evaluate the information content according to the information statistics obtained by the generalized rule induction information statistics calculation module, and to generate a best relationship rule by the information theoretic rule induction algorithm module for establishing associate rule module.

10. The system as claimed in claim 9, wherein the generalized rule induction information statistics calculation module retrieves statistics as follow:
$$J = p ( a ) [ p ( b \vert a ) ln \frac{p ( b \vert a )}{p ( b )} + [ 1 - p ( b \vert a ) ] ln \frac{1 - p ( b \vert a )}{1 - p ( b )} ] ,$$
in which the p(a) represents the probability of factor observation value a, i.e. covering degree of the antecedent of the rule; the p(b) represents the prior probability of factor observation value b,that is the general degree of consequent; the p(b|a) represents the correction probability of factor observation value b after added observation value a; and for a rule with multi-antecedent, the P(a) is treated as a joint probability of the antecedent with multi-observation values.

11. The system as claimed in claim 9, wherein the information theoretic rule induction algorithm module is configured to generate a best rule and establish associate rule module by the following steps of:
Step 1: retrieving a rule with designated quantity by calculating and sequentially arranging all J statistics of first-order rules from sample data, and setting the minimum J statistics as the Jₘᵢₙ;
Step 2: characterizing all rules in Step 1, that is, adding new antecedent and then evaluating the J statistics of newly formed rules;
Step 3: determining whether continuously characterizing the rules by a depth-first algorithm strategy, and replacing the elder rule by the searched rule with the J statistics larger than the Lₘᵢₙ until the P(b|a) equals to 0 or 1.

12. The system as claimed in claim 8, wherein the disease is leukemia, and the threshold value range of the gene expression is from −800 to 24000.

13. A computer readable medium with stored program, when the computer install and execute the program, it is able to perform the system as claimed in claim 1.

14. A computer readable medium with stored program, when the computer installs and executes the program, it is able to perform the system as claimed in claim 7.
